(19) United States
(12) Patent Application Publication
(10) Pub. No.: US 2014/0369534 A1
(43) Pub. Date: Dec. 18, 2014

(54) SOUND PICKUP SYSTEM AND TERMINAL DEVICE USING THE SAME

(71) Applicants: Chao Wang, Shenzhen (CN); Qi Tang, Shenzhen (CN)

(72) Inventors: Chao Wang, Shenzhen (CN); Qi Tang, Shenzhen (CN)

(73) Assignees: AAC ACOUSTIC TECHNOLOGIES (SHENZHEN) CO., LTD., Shenzhen (CN); AAC ACOUSTIC TECHNOLOGIES (CHANGZHOU) CO., LTD., Changzhou (CN); AAC TECHNOLOGIES (NANJING) CO., LTD., Nanjing (CN)

(21) Appl. No.: 14/162,967

(22) Filed: Jan. 24, 2014

(30) Foreign Application Priority Data
Jun. 13, 2013 (CN) 201310233440.7

(51) Int. Cl. H04R 17/02

(52) U.S. Cl. CPC H04R 17/02
USPC 381/173; 381/178

(57) ABSTRACT

A sound pickup system is disclosed. The sound pickup system includes a screen, an accelerometer attached to the screen, and a pre-processing module electrically connecting with the accelerometer. The screen is configured to detect a vibration caused by sound waves, the accelerometer is configured to receive the vibration detected by the screen and convert the vibration into an acceleration signal, and the pre-processing module is configured to receive the acceleration signal, and process the acceleration signal then convert the processed acceleration signal into a voice signal.

### FIELD OF THE DISCLOSURE

The present invention generally relates to the technical field of electro-acoustic transformation, and more particularly, to a sound pickup system containing a screen and a terminal device using the system.

### BACKGROUND OF THE DISCLOSURE

Accelerometers are a kind of sensors capable of sensing acceleration and transforming the acceleration into a usable output signal, and are also a kind of electronic devices capable of measuring the acceleration force (also known as accelerators). The accelerators are generally classified into uni-axis accelerators, bi-axis accelerators and three-axis accelerators, according to the number of input axes thereof. The accelerators are often used in some modern terminal devices. For example, three-axis accelerators are typically used in smart mobile phones for being available to detect accelerations in any direction.

However, the three-axis accelerators used in the smart mobile phones are usually only used to detect such physical parameters as the tilting angle, the acceleration or the like. Actually, more new functions can be achieved by using the three-axis accelerators in the mobile phones.

It has been found through experiments that, when a user talks with the mobile phone being in close contact with the user's face or being adjacent to the user's mouth, the screen of the mobile phone will vibrate at a vibration frequency consistent with the voice frequency of the user. In addition, a conventional mobile phone uses a microphone to pickup a user's voices and to convert the voices to electrical signals. For accommodating a microphone, the mobile phone shall provide an extra space, which increases the volume of the mobile phone. Further, using a microphone cannot effectively filter ambient noises. Therefore, an improved sound pickup system is desired.

### BRIEF DESCRIPTION OF THE DRAWINGS

FIG. 1 is a schematic view of a sound pickup system in accordance with an exemplary embodiment of the present invention;

FIG. 2 is a schematic view of the sound pickup system using a piezoelectric accelerometer cooperatively with a screen; and

FIG. 3 is a block diagram of a terminal device using the sound pickup system.

Many aspects of the embodiment can be better understood with reference to the drawings mentioned above. The components in the drawings are not necessarily drawn to scale, the emphasis instead being placed upon clearly illustrating the principles of the present disclosure. Moreover, in the drawings, like reference numerals designate corresponding parts throughout the several views.

### DETAILED DESCRIPTION OF THE DISCLOSURE

Reference will now be made to describe the exemplary embodiment of the present invention in detail.

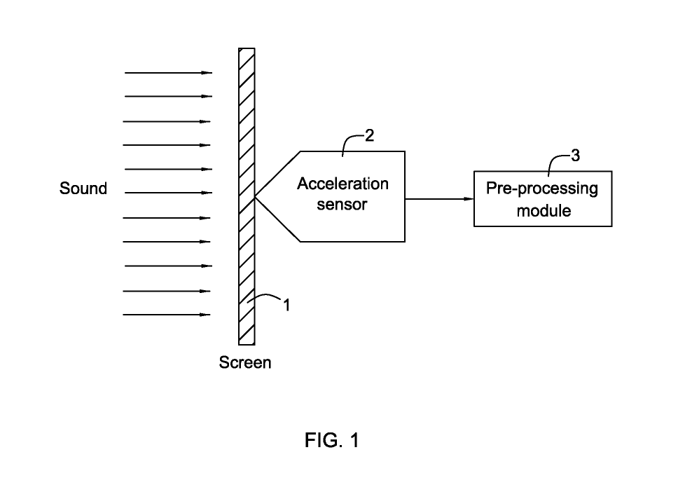

As shown in FIG. 1, a sound pickup system in accordance with an exemplary embodiment of the present invention, comprises a screen 1 configured for sensing vibration caused by sound waves produced by a user, an accelerometer 2 configured for receiving the vibration sensed by the screen 1 and converting the vibration into acceleration signals, and a pre-processing module 3 configured for receiving the acceleration signals, processing the acceleration signals and then converting the processed acceleration signals into audio signals.

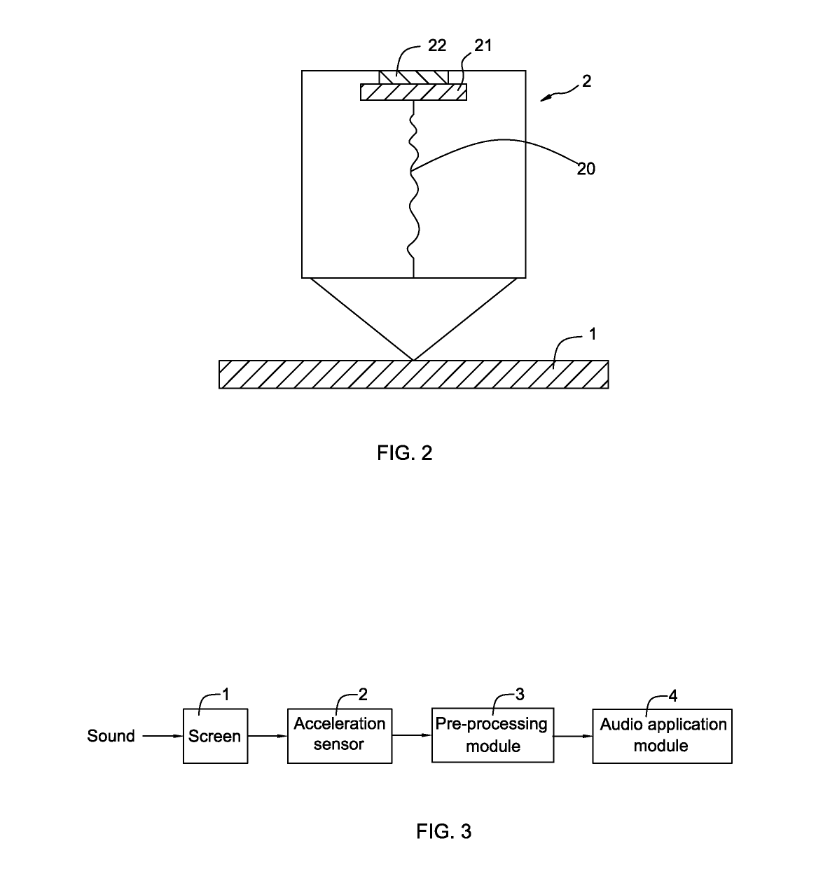

FIG. 2 is a schematic view illustrating the operation principal of the sound pickup system of the exemplary embodiment. When sound waves arrive at the screen 1, the screen vibrates at a resonance frequency corresponding to the waves, by which vibration caused by the waves are detected. Actually, this configuration is not only designed for detecting sound waves, but also for detecting vibrations from bones of a user. For example, when the user talks with face touching the screen 1, the vibration from the bones according to the vibration of the vocal cord activates the screen 1 to resonant. Therefore, the screen 1 is configured to detect vibrations cause by sound waves, or to detect vibrations from bones of a user. To put it to simple, the screen is designed to detect vibrations containing audible information.

Referring to FIGS. 1 and 2, the accelerometer 2 used in the exemplary embodiment is a piezoelectric accelerometer. It should be easily understood that other type of accelerometer could also be used. FIG. 2 shows a schematic view of a piezoelectric accelerometer 2 cooperating with the screen 1. The accelerometer 2 comprises a spring 20, a mass block 21 connected with the spring 20, and a piezoelectric sheet 22 attached to the mass block 21. The piezoelectric accelerometer 2 is further fixed to the screen 1 directly or indirectly to sense the vibration detected by the screen 1. Once a vibration is sensed by the piezoelectric accelerometer 2, the mass block 21 will receive the same vibration as the screen 1 subjected to an inertia force in a direction opposite to the acceleration. Thus, an alternating force in direct proportion to the acceleration will be imposed by the mass block 21 on the piezoelectric sheet 22. Because of the piezoelectric effect of the piezoelectric sheet 22, alternating electric charges will be generated on an upper surface and a lower surface of the piezoelectric sheet 22. When the vibration frequency is much lower than the inherent frequency of the piezoelectric accelerometer, the electric charges output by the piezoelectric accelerometer is in direct proportion to the acting force.

The output power of the piezoelectric accelerometer is output from an output end thereof into a pre-amplifier so that the acceleration of the screen 1 can be measured by a common measurement instrument. If an appropriate integration circuit is added in the pre-amplifier, the vibration speed or displacement of the screen 1 can be measured.

The mass of the mass block 21 inside the piezoelectric accelerometer and the mechanical compliance of the spring 20 dictate an upper limit of the vibration frequency that can be detected by the piezoelectric accelerometer.

The free vibration frequency of the mass block 21 and the spring 20 could be calculated by the formula as follows:

$${f}_{0} = \frac{1}{2 π} \sqrt{\frac{1}{MC}}$$

Where f₀ is the free vibration frequency of the combination of the mass block and the spring, M is the mass of the mass block 21, and C is the mechanical compliance of the spring 20.

During testing of the vibration system, the operation frequency band generally shall be lower than the frequency f₀ of the combination of the mass block 21 and the spring 20, in which case the combination operates in an elastically controlled state.

Assuming that the screen 1 vibrates at a single frequency with a fixed amplitude in the elasticity controlled state, an output voltage Eₐ may be represented by the following formula:

$${E}_{a} = τ \frac{{M}_{m} {a}_{10}}{ω \vert {Z}_{m} \vert}$$

where:
Mₘ is the mass of the mass block 21;
a₁₀ is the acceleration of the screen 1;
τ is a constant;
Zₘ is a force impedance modulus value of the system.

When the vibration frequency of the screen 1 is much lower than f₀, the above formula may be equivalently represented as:

$${E}_{a} = \frac{τ {a}_{10}}{{ω}_{0}^{2}}$$

For the screen 1 having a fixed amplitude, the acceleration thereof at a balanced position is directly proportional to the square of the frequency, so the amplitude of the output voltage is independent of the frequency.

Of course, as a further improvement of the description above, the accelerometer is not merely limited to the piezoelectric accelerometer, but may also be other kinds of accelerometers. Specifically, sensors capable of sensing the acceleration and converting the acceleration into a usable output signal shall all fall into the scope of the present invention.

Referring to FIG. 3, a block diagram of a terminal device using the sound pickup system of the present invention is shown therein. In this embodiment, the terminal device may be a mobile phone, a tablet or the like.

Usually, three-axis accelerators are adopted in mobile phones. In practice, three one-dimensional accelerators are assembled together to detect accelerations in arbitrary directions. Therefore, when the accelerometer 2 is installed in a mobile phone, it is only necessary to ensure that there is one axis thereof being perpendicular to the screen. Then, acceleration information of this axis can be picked up directly and processed by the pre-processing module 3 so that voice signals can be output.

Optionally, the pre-processing module 3 used in the present invention comprises an analog-to-digital (AD) converter, and may further comprises a band-pass filter which may be either an analog or a digital band-pass filter.

The terminal device using the aforesaid sound pickup system of the present invention further comprises an audio application module 4, which is configured to receive and apply the voice signals. The audio application module 4 refers to a program (i.e., a software application) that operates with audio information for purpose of sound recording, calling, or using the voice signal as a reference signal for uplink noise-cancellation.

According to the sound pickup system and the terminal device using the system, the sound pickup system is used to allow the screen 1 to pickup sound in the ambient environment and convert the screen vibration caused by the sound into voice signals. By virtue of this configuration, the traditional microphone used in a mobile phone for receiving voices/sounds could be omitted, and further, the volume of the mobile phone could be reduced.

What described above are only exemplary embodiments of the present disclosure. It shall be appreciated that, for those of ordinary skill in the art, modifications may be made thereto without departing from the inventive concepts of the present disclosure, and all these modifications shall fall within the scope of the present disclosure.

What is claimed is:

1. A sound pickup system, comprising:
a screen for detecting a vibration containing audible information,
an accelerometer attached to the screen for receiving the vibration detected by the screen and converting the vibration into acceleration signals, and
a pre-processing module electrically connecting with the accelerometer for receiving the acceleration signal and converting the acceleration signals into voice signals.

2. The sound pickup system of claim 1, wherein the accelerometer is a piezoelectric accelerometer.

3. The sound pickup system of claim 1, wherein the accelerometer has at least one axis perpendicular to the screen.

4. The sound pickup system of claim 1, comprising a plurality of one-dimensional accelerometers, wherein at least one of the one-dimensional accelerometers has an axis perpendicular to the screen.

5. The sound pickup system of claim 1, wherein the pre-processing module comprises an analog-to-digital converter and a band-pass filter electrically connected with each other.

6. A terminal device, comprising:
a sound pickup system, wherein the sound pickup system comprises:
a screen for detecting a vibration containing audible information,
an accelerometer attached to the screen for receiving the vibration detected by the screen and converting the vibration into acceleration signals, and
a pre-processing module electrically connecting with the accelerometer for receiving the acceleration signal and converting the acceleration signals into voice signals.

7. The terminal device of claim 6, further comprising an audio application module configured for receiving and applying the voice signals.
